(19) United States
(12) Patent Application Publication
(10) Pub. No.: US 2026/0196187 A1
(43) Pub. Date: Jul. 9, 2026

(54) IMAGE PROCESSING APPARATUS CAPABLE OF APPLYING IMAGE ADJUSTMENTS TO IMAGES

(71) Applicant: CANON KABUSHIKI KAISHA, Tokyo (JP)

(72) Inventors: TAKAHIRO KITSUNAI, Tokyo (JP); SHINICHI HAGIWARA, Tokyo (JP); TAKASHI MIZUNO, Tokyo (JP)

(21) Appl. No.: 19/442,301

(22) Filed: Jan. 7, 2026

(30) Foreign Application Priority Data
Jan. 9, 2025 (JP) 2025-003401

(51) Int. Cl. G09G 5/10; G09G 5/00

(52) U.S. Cl. CPC G09G 5/10; G09G 5/003; G09G 2320/0666; G09G 2320/0673; G09G 2354/00

(57) ABSTRACT

An image processing apparatus according to the present disclosure includes one or more processors configured to: execute switching processing of switching a current mode among a plurality of image adjustment modes; execute image adjustment processing of applying one or more image adjustments to an image in the current mode; and execute display control processing of controlling display so as to display, for each of the plurality of image adjustment modes, details of the one or more image adjustment applied to the image in a case where the current mode is switched to the image adjustment mode.

### BACKGROUND

### FIELD OF THE TECHNOLOGY

The present disclosure relates to an image processing apparatus capable of applying image adjustments to images.

### DESCRIPTION OF THE RELATED ART

Environments that enable high dynamic range (hereinafter referred to as “HDR”) images to be adjusted and displayed are becoming increasingly widespread. Consequently, systems capable of image adjustment and display images suitable for HDR environments within the HDR color gamut have emerged. On the other hand, since display environments in the conventional standard dynamic range (hereinafter referred to as “SDR”) continue to be utilized, image adjustment and display suitable for SDR environments are still in demand. For this reason, systems capable of executing image adjustments by switching between image adjustment (display) suitable for SDR environments and image adjustment (display) suitable for HDR environments have also emerged.

Japanese Patent Application Laid-open No. 2020-25178 discloses that an information processing apparatus detects a need for readjustment of adjustment parameters which yield images with characteristics that differ between SDR environments and HDR environments (parameters appropriate for each environment differ) when the adjustment parameters have been adjusted. In addition, the information processing apparatus notifies a user that readjustment of the adjustment parameters is required.

Japanese Patent Application Laid-open No. 2020-35294 describes a history display method that displays adjustment details so as to enable a user to distinguish between adjustment details being applied and adjustment details not being applied to a current image with respect to each adjustment item within an adjustment history.

However, with the techniques described above, when there are adjustment items that cannot be applied universally across a plurality of image adjustment modes such as SDR and HDR, the user cannot confirm an application state of different image adjustment for each image adjustment mode. As a result, an image representing a processing result when switching image adjustment modes ends up in an unexpected state.

### SUMMARY

The present disclosure provides an apparatus and method to make an application state of image adjustment for each image adjustment mode readily confirmable.

An aspect of the present disclosure provides an image processing apparatus, including one or more processors and one or more memories storing a program which, when executed by the one or more processors, causes the one or more processors to: execute switching processing of switching a current mode among a plurality of image adjustment modes; execute image adjustment processing of applying one or more image adjustments to an image in the current mode; and execute display control processing of controlling display so as to display, for each of the plurality of image adjustment modes, details of the one or more image adjustment applied to the image in a case where the current mode is switched to the image adjustment mode.

Features of the present disclosure will become apparent from the following description of embodiments with reference to the attached drawings. The following description of embodiments is described by way of example.

### BRIEF DESCRIPTION OF THE DRAWINGS

FIG. 1 is a hardware configuration diagram of an image processing apparatus.

FIG. 2 is a functional configuration diagram of the image processing apparatus.

FIG. 3 is a diagram illustrating a GUI for switching adjustment modes.

FIG. 4 is a diagram illustrating image adjustment processing.

FIG. 5 is a diagram illustrating functional units included in the image processing apparatus for performing image adjustment.

FIGS. 6A and 6B are diagrams illustrating tables for determining whether or not adjustment details can be applied.

FIG. 7 is a flow chart illustrating operations of the image processing apparatus.

FIG. 8 is a flow chart illustrating operations of history display.

FIG. 9 is a diagram illustrating history display.

### DESCRIPTION OF THE EMBODIMENTS

Hereinafter, an embodiment of the present disclosure will be described with reference to the drawings.

For example, an image processing apparatus according to the present embodiment acquires a record file of a raw image captured by a digital camera. In addition, the image processing apparatus develops the raw image in the record file (converts the raw image into an image format visually recognizable by humans). Furthermore, during development processing, the image processing apparatus is capable of switching between executing “image adjustment suitable for an SDR environment” and “image adjustment suitable for an HDR environment.”

Whether to perform image adjustment suitable for an SDR environment or image adjustment suitable for an HDR environment can be based on, for example, user selection. Note that an SDR environment refers to an environment in which image adjustment or display is performed in a standard dynamic range (SDR). An HDR environment refers to an environment in which image adjustment or display is performed in a high dynamic range (HDR) that is a wider dynamic range than the SDR.

While adjustment modes that can be set in the image processing apparatus in the present embodiment include an SDR adjustment mode and an HDR adjustment mode, adjustment modes are not limited thereto. Modes with differing image characteristic settings including differing “color gamuts” such as sRGB and Adobe RGB and differing “gamma” settings such as LOG gamma may be treated as single adjustment modes. For example, modes with different characteristic settings such as HLG and PQ in HDR are treated as separate adjustment modes.

In the present embodiment, the description of image processing performed by the image processing apparatus will be divided between “image processing from development processing to gamma processing (γ processing)” and “image processing performed with respect to an image after γ processing.”

The “image processing from development processing to gamma processing (γ processing)” includes image adjustments such as white balance processing, digital gain processing, noise reduction processing, correction processing according to lens characteristics, and correction processing according to photography modes set in advance. In addition, in γ processing, for example, γ of 1/2.2 is particularly used as gamma characteristics (γ characteristics) suitable for an SDR environment and γ of a perceptual quantization (PQ) system is used as γ characteristics suitable for an HDR environment. In other words, in the image processing apparatus according to the present embodiment, γ characteristics of 1/2.2 are particularly used when performing image adjustment suitable for an SDR environment and γ characteristics of a PQ system are particularly used when performing image adjustment suitable for an HDR environment.

The “image processing performed with respect to an image after the γ processing” includes at least one image adjustment such as RGB tone curve adjustment, color adjustment such as 8-axis color adjustment, partial adjustment in an image, copy stamp processing that involves copying and pasting regions in an image, cropping, rotation processing, or scaling. In addition, in the image processing apparatus according to the present embodiment, when performing image adjustment, adjustment parameters optionally designated by a user or adjustment parameter sets prepared separately can also be used.

In the following description, the image processing from development processing to γ processing described above will be referred to as a “first image adjustment.” In addition, the image adjustment performed after the first image adjustment will be referred to as a “second image adjustment.” Furthermore, in the present embodiment, an adjustment parameter used in the first image adjustment will be referred to as a “first adjustment parameter” and an adjustment parameter used in the second image adjustment will be referred to as a “second adjustment parameter.”

The first adjustment parameters include respective setting values of white balance processing, digital gain processing, noise reduction processing, correction processing of lens characteristics, photography modes set in advance, and γ processing, as described above.

The second adjustment parameters include respective setting values of RGB tone curve adjustment, color adjustment such as 8-axis color adjustment, partial adjustment, copy stamp processing, cropping, rotation processing, and scaling, as described above.

### Hardware Configuration of Image Processing Apparatus

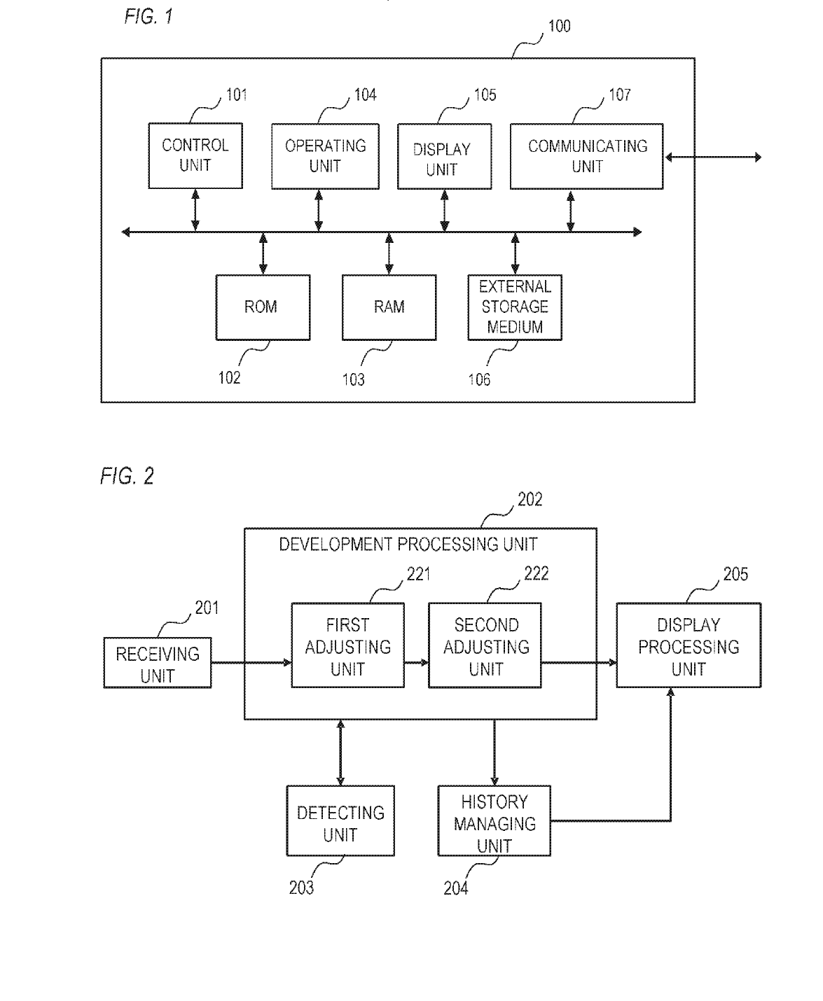

FIG. 1 is a hardware configuration diagram of an image processing apparatus 100 according to the present embodiment. The image processing apparatus 100 includes a control unit 101, a ROM 102, a RAM 103, an operating unit 104, a display unit 105, an external storage medium 106, and a communicating unit 107.

The control unit 101 is an arithmetic processing apparatus (CPU) that controls the entire image processing apparatus 100. In addition, the control unit 101 controls editing processing of images (image processing) and processing of managing a history of editing processing (history management processing).

The ROM 102 is a hard disk drive, an SSD (solid state drive), or the like. The ROM 102 records, in a readable format, an execution program for the image editing processing, digital data such as encoded image signals, and the like.

Program code and digital data recorded in the ROM 102 are loaded into the RAM 103.

The operating unit 104 includes a keyboard, a mouse, a touch operating unit, or the like. When the control unit 101 detects an input from the operating unit 104, processing is performed according to a program loaded into the RAM 103.

The display unit 105 is a cathode ray tube (CRT) display, a liquid crystal panel display, or the like. The display unit 105 displays various types of information. In the present embodiment, the operating unit 104 and the display unit 105 are integrally provided as a touch panel.

The external storage medium 106 is capable of storing images and image editing results generated by applying editing processing to the images.

The communicating unit 107 is an interface for connecting to a network line such as the Internet or an interface for communicating with external devices. The communicating unit 107 receives an image to be edited.

Note that the control unit 101 reads an image editing processing application program (hereinafter, referred to as an “image adjustment application”) stored in the ROM 102 or the external storage medium 106 and executes the image adjustment application. Accordingly, functions and processing of the image processing apparatus 100 are realized.

In addition, the image processing apparatus 100 may be realized by a single computer apparatus. Alternatively, the image processing apparatus 100 may be realized by having a plurality of computer apparatuses execute the respective functions of the image processing apparatus 100 in a distributed manner as needed. When the image processing apparatus 100 is constituted of a plurality of computer apparatuses, the plurality of computer apparatuses are connected via communication such as a local area network (LAN) so as to be capable of transmitting and receiving various kinds of data and commands to and from each other.

### Functional Configuration of Image Processing Apparatus

FIG. 2 is a diagram illustrating a functional configuration of the image processing apparatus 100. The image processing apparatus 100 includes a receiving unit 201, a development processing unit 202, a detecting unit 203, a history managing unit 204, and a display processing unit 205.

The receiving unit 201 receives various instructions according to user operations. Via the receiving unit 201, for example, the user issues an “instruction to switch adjustment modes,” an “instruction to set a first adjustment parameter to be used in the first image adjustment,” and an “instruction to set a second adjustment parameter to be used in the second image adjustment.” Instructions from the user are sent to the development processing unit 202 (control unit 101). Accordingly, for example, the development processing unit 202 controls operations of the image processing apparatus 100 and sets the respective adjustment parameters according to the image adjustment mode selected by the user.

The “instruction to switch adjustment modes” is an instruction to select either the image adjustment mode suitable for an SDR environment (hereinafter, referred to as an “SDR image adjustment mode”) or the image adjustment mode suitable for an HDR environment (hereinafter, referred to as an “HDR image adjustment mode”). Details regarding switching adjustment modes in response to user operations will be described later.

In addition, regarding the “instruction to set a first adjustment parameter,” respective setting values of white balance processing, digital gain processing, noise reduction processing, correction processing of lens characteristics, photography modes, or γ processing are input or selected.

Regarding the “instruction to set a second adjustment parameter,” respective setting values of RGB tone curve adjustment, color adjustment such as 8-axis color adjustment, partial adjustment, copy stamp processing, cropping, rotation processing, or scaling are input or selected.

The development processing unit 202 operates as an “image processing unit” that performs development processing of an original image (in the present embodiment, a raw image). In addition, the development processing unit 202 also operates as a “mode selecting unit” that sets the image adjustment mode selected by the user as an adjustment mode of the image processing apparatus 100. The development processing unit 202 includes a first adjusting unit 221 and a second adjusting unit 222.

The first adjusting unit 221 is a processing unit that executes the first image adjustment according to the adjustment mode of the image processing apparatus 100 (the image adjustment mode selected by the user). In other words, when the HDR image adjustment mode is selected, the first adjusting unit 221 executes first image adjustment suitable for an HDR environment. When the SDR image adjustment mode is selected, the first adjusting unit 221 executes first image adjustment suitable for an SDR environment.

The second adjusting unit 222 is a processing unit that executes the second image adjustment on an image after the first image adjustment by the first adjusting unit 221.

The detecting unit 203 determines (detects) whether or not readjustment of the adjustment parameter used for image adjustment is necessary. In the present embodiment, particularly, the detecting unit 203 determines whether or not readjustment of the second adjustment parameter applied in the second image adjustment is necessary.

The history managing unit 204 manages, as history information, values of editing processing such as exposure and white balance in the adjustment of a series of development processing (adjustment parameters), an order in which the editing processing was performed, and the like. The history managing unit 204 stores the history information in a predetermined recording area of the external storage medium 106. In addition, the history managing unit 204 also records, as history information, an order in which editing processing such as rotation and cropping has been performed with respect to the raw image as well as angles and coordinates regarding the rotation and the cropping.

The display processing unit 205 is a processing unit (display control unit) that controls display of the history information managed by the history managing unit 204, a GUI for selecting image adjustment modes, and the like. The display processing unit 205 converts an image after the second image adjustment by the second adjusting unit 222 into an image for display. The display processing unit 205 displays the image for display on the display unit 105.

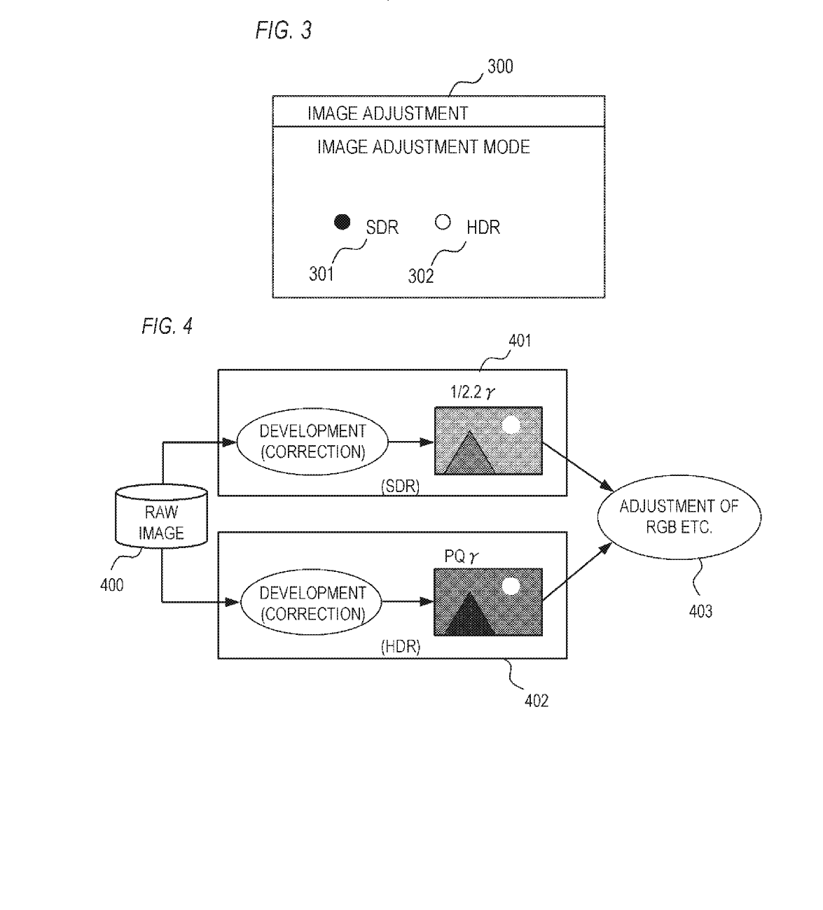

FIG. 3 is a diagram illustrating an example of a graphical user interface (GUI) in the image processing apparatus 100 when the user switches between adjustment modes of the image processing apparatus 100. FIG. 3 shows an example of a GUI 300 when setting either of two modes, the SDR image adjustment mode or the HDR image adjustment mode, by selecting option buttons (radio buttons). The GUI 300 is displayed on the display unit 105.

As shown in FIG. 3, the GUI 300 for selecting an image adjustment mode is provided with an option button 301 and an option button 302. The option button 301 is a button for selecting the SDR image adjustment mode. The option button 302 is a button for selecting the HDR image adjustment mode.

The user can select an adjustment mode by selecting either the option button 301 or the option button 302 via an operation of the receiving unit 201. For example, when the option button 301 is selected, the first adjusting unit 221 executes image adjustment in a state where adjustment parameters suitable for an SDR environment have been set. On the other hand, when the option button 302 is selected, the first adjusting unit 221 executes image adjustment in a state where adjustment parameters suitable for an HDR environment have been set.

FIG. 4 is a diagram illustrating a flow of image adjustment processing according to a selection result of an adjustment mode.

First, a raw image 400 (record file) of an original image stored in the ROM 102 or the external storage medium 106 is input into the first adjusting unit 221. Subsequently, when the selected image adjustment mode is the SDR image adjustment mode, the first adjusting unit 221 performs first image adjustment 401 suitable for an SDR environment on the raw image 400. In the first image adjustment 401, γ processing suitable for SDR display (for example, γ processing using γ characteristics of 1/2.2) is performed after development processing or the like.

On the other hand, when the selected image adjustment mode is the HDR image adjustment mode, the first adjusting unit 221 performs first image adjustment 402 suitable for an HDR environment on the raw image 400. In the first image adjustment 402, γ processing suitable for HDR display (for example, γ processing using γ characteristics of a PQ system) is performed after development processing or the like.

In addition, the second adjusting unit 222 performs second image adjustment 403 such as RGB tone curve adjustment on the image data after the first image adjustment (first image adjustment 401 or first image adjustment 402) by the first adjusting unit 221 is performed.

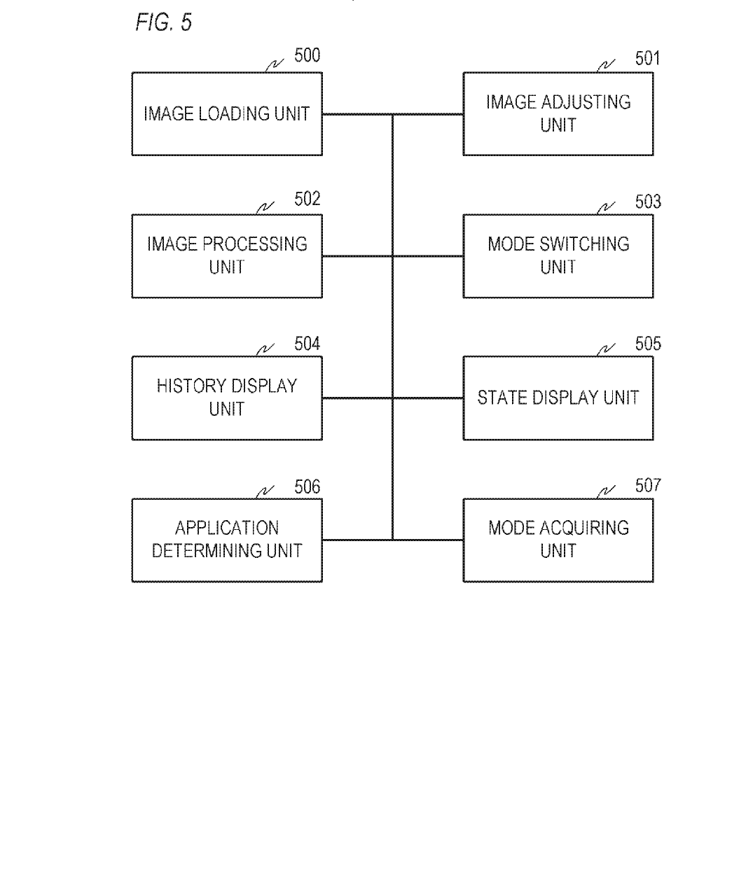

Functional units (processing units) included in the image processing apparatus 100 for realizing image adjustment will be described with reference to FIG. 5. The image processing apparatus 100 includes an image loading unit 500, an image adjusting unit 501, an image processing unit 502, a mode switching unit 503, a history display unit 504, a state display unit 505, an application determining unit 506, and a mode acquiring unit 507.

The image loading unit 500 loads image data from the external storage medium 106.

The image adjusting unit 501 receives an image adjustment operation by the user with respect to the operating unit 104 and executes image adjustment with respect to the image data.

The image processing unit 502 generates an image by subjecting the image data to image processing (including white balance processing and digital gain processing) using the development processing unit 202.

The mode switching unit 503 switches (sets) the adjustment mode (current adjustment mode) of the image processing apparatus 100 according to a selection result of the image adjustment mode described with reference to FIG. 3. Due to the switching of the adjustment mode of the image processing apparatus 100, the parameters to be used during image generation by the image processing unit 502 are changed so as to correspond to the adjustment mode after the switching.

The history display unit 504 performs history display on the display processing unit 205 using history information of a specific image adjustment mode managed by the history managing unit 204.

The state display unit 505 performs, using the history display unit 504, a plurality of history displays corresponding to the plurality of image adjustment modes that can be switched by the mode switching unit 503.

The application determining unit 506 determines, for each image adjustment mode, whether or not adjustment details corresponding to the image adjustment operation by the user received by the image adjusting unit 501 can be applied (realized) with respect to the image. Whether or not the adjustment details can be applied to the image is determined based on the current adjustment mode, the adjustment details, and the like. More specifically, for each image adjustment mode, the application determining unit 506 determines whether or not adjustment details corresponding to the image adjustment operation can be applied with respect to the image when the adjustment mode of the image processing apparatus 100 is switched to the image adjustment mode.

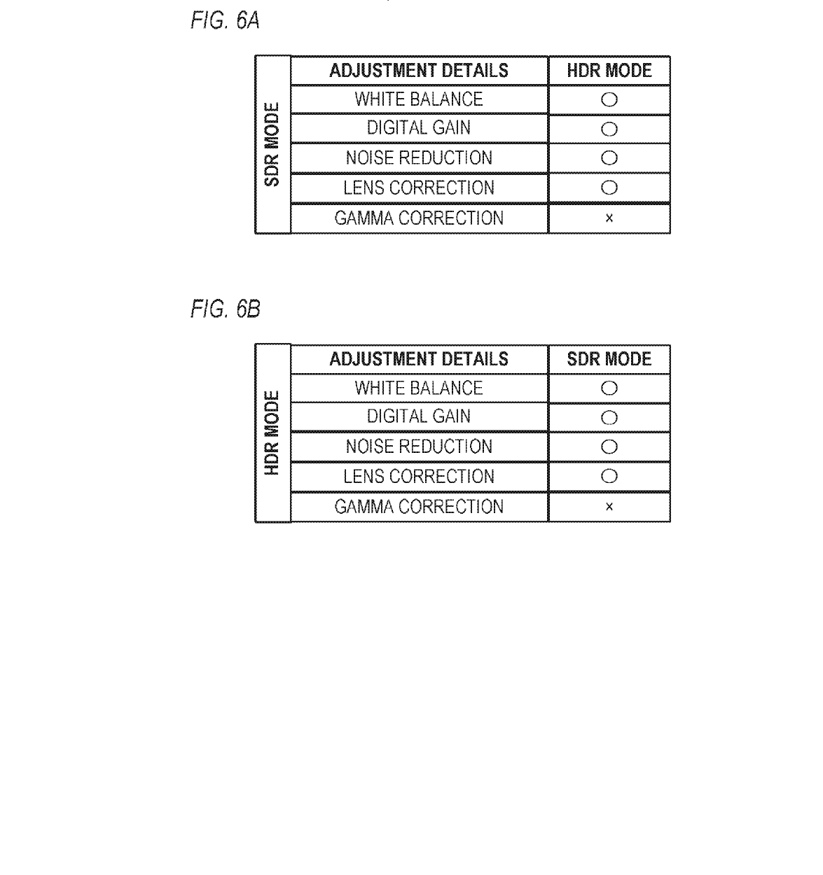

For example, let us assume a case where the current adjustment mode is the SDR image adjustment mode, the adjustment details are gamma correction, and the image adjustment mode to be determined is the HDR image adjustment mode. In such a case, gamma correction is to be significantly influenced by the image characteristics of SDR and HDR, making it highly likely that the image processing results upon adjustment application will deviate from the expectations of the user. Therefore, the application determining unit 506 determines that the adjustment details cannot be applied to the image in the image adjustment mode to be determined. In addition, whether or not adjustment details are to be applied may be defined by a table or the like in advance as shown in FIGS. 6A and 6B for each combination of adjustment details and an image adjustment mode. FIG. 6A shows, for each adjustment detail, whether or not the adjustment detail is to be applied when the current adjustment mode is the SDR image adjustment mode and the image adjustment mode to be determined is the HDR image adjustment mode. FIG. 6B shows, for each adjustment detail, whether or not the adjustment detail is to be applied when the current adjustment mode is the HDR image adjustment mode and the image adjustment mode to be determined is the SDR image adjustment mode. FIGS. 6A and 6B show that gamma correction cannot be applied uniformly to an image between the SDR image adjustment mode and the HDR image adjustment mode. On the other hand, FIGS. 6A and 6B show that image adjustment of white balance, digital gain, noise reduction, and lens correction (correction of lens characteristics) can be applied uniformly to an image between the SDR image adjustment mode and the HDR image adjustment mode.

The mode acquiring unit 507 acquires information related to the image adjustment mode. For example, the information related to the image adjustment mode includes information on the current adjustment mode of the image processing apparatus 100 or a list of image adjustment modes to which the image processing apparatus 100 can be switched.

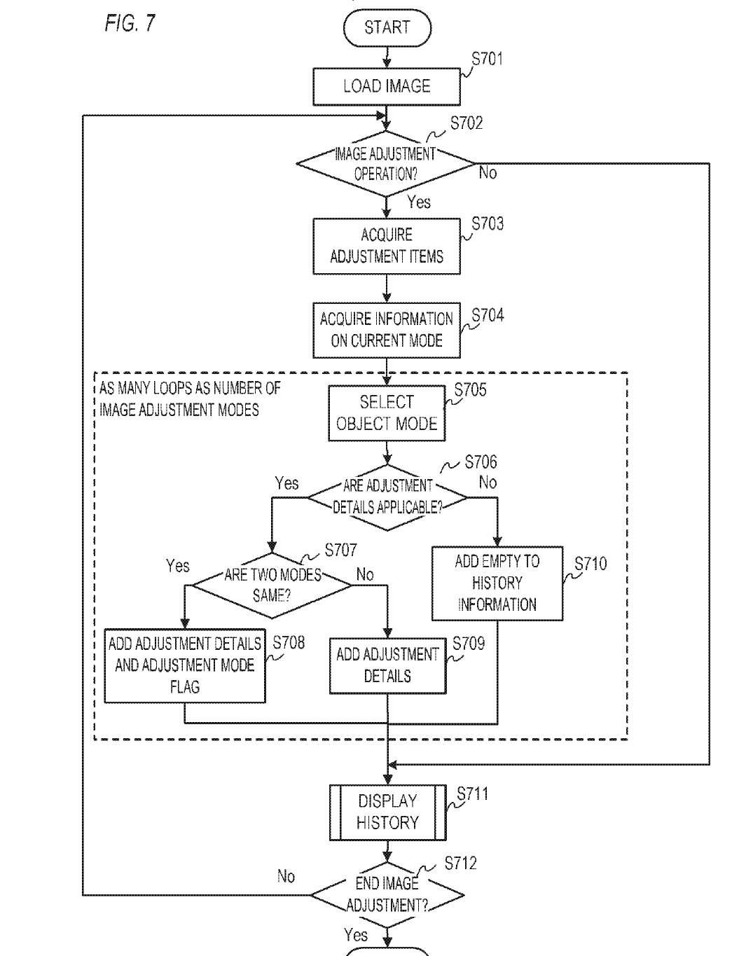

Operations of the image processing apparatus 100 will be described with reference to the flow chart shown in FIG. 7.

In step S701, the image loading unit 500 loads an image (for example, a captured image of a real space having been captured by an image capturing apparatus).

In step S702, the image adjusting unit 501 determines whether or not the user has performed an image adjustment operation. When it is determined that an image adjustment operation has been performed, the image adjusting unit 501 advances the processing to step S703. When it is determined that an image adjustment operation has not been performed, the image adjusting unit 501 advances the processing to step S711.

In step S703, the image adjusting unit 501 acquires image adjustment details corresponding to the image adjustment operation. The image adjustment details include adjustment items and adjustment parameters. In addition, the image adjusting unit 501 executes adjustment according to the image adjustment details with respect to the image loaded in step S701.

In step S704, the mode acquiring unit 507 acquires information on the current adjustment mode (hereinafter, referred to as a “current mode”) of the image processing apparatus 100. The current mode can be switched by the mode switching unit 503 according to a user operation.

In subsequent steps S705 to S710, processing is individually performed with respect to each of a plurality of switchable image adjustment modes. Therefore, the processing of steps S705 to S710 is performed in as many loops as the number of image adjustment modes.

In step S705, the mode acquiring unit 507 selects one image adjustment mode (hereinafter, referred to as an “object mode”) to be an object of the present loop processing among the plurality of switchable image adjustment modes.

In step S706, the application determining unit 506 determines whether or not the image adjustment details acquired in step S703 can be applied to an image in the object mode (in other words, whether or not the image adjustment details are applied to the image when the current mode is switched to the object mode). When it is determined that the image adjustment details can be applied to the image in the object mode, the application determining unit 506 advances the processing to step S707. When it is determined that the image adjustment details cannot be applied to the image in the object mode, the application determining unit 506 advances the processing to step S710.

In step S707, the application determining unit 506 determines whether or not the current mode and the object mode are the same mode. When the two modes are determined to be the same, the application determining unit 506 advances the processing to step S708. When the two modes are determined to be different, the application determining unit 506 advances the processing to step S709.

In step S708, the application determining unit 506 adds a combination of the image adjustment details and an adjustment mode flag as operation history to the history information corresponding to the object mode. The adjustment mode flag is a flag indicating that the image adjustment mode during image adjustment and the image adjustment mode corresponding to operation history are the same. The adjustment mode flag is used in the history display unit 504 to indicate which image adjustment mode was used to perform image adjustment. Note that when explicit indication of the image adjustment mode during adjustment is unnecessary, the application determining unit 506 advances the processing directly from step S706 to step S709 without performing the processing in steps S707 and S708.

In step S709, the application determining unit 506 adds the image adjustment details as operation history to the history information corresponding to the object mode.

In step S710, because image adjustment is not applied to the image in the object mode, the application determining unit 506 sets the image adjustment details to empty. In addition, the application determining unit 506 adds the image adjustment details as operation history to the history information corresponding to the object mode.

In step S711, the history display unit 504 and the state display unit 505 perform display of history information. Details of the processing of step S711 will be provided later.

In step S712, a determination is made as to whether or not the image adjustment by the user has been finished. When it is determined that the image adjustment has been finished, the processing of the present flow chart is ended. When it is determined that the image adjustment has not been finished, the processing advances to step S702.

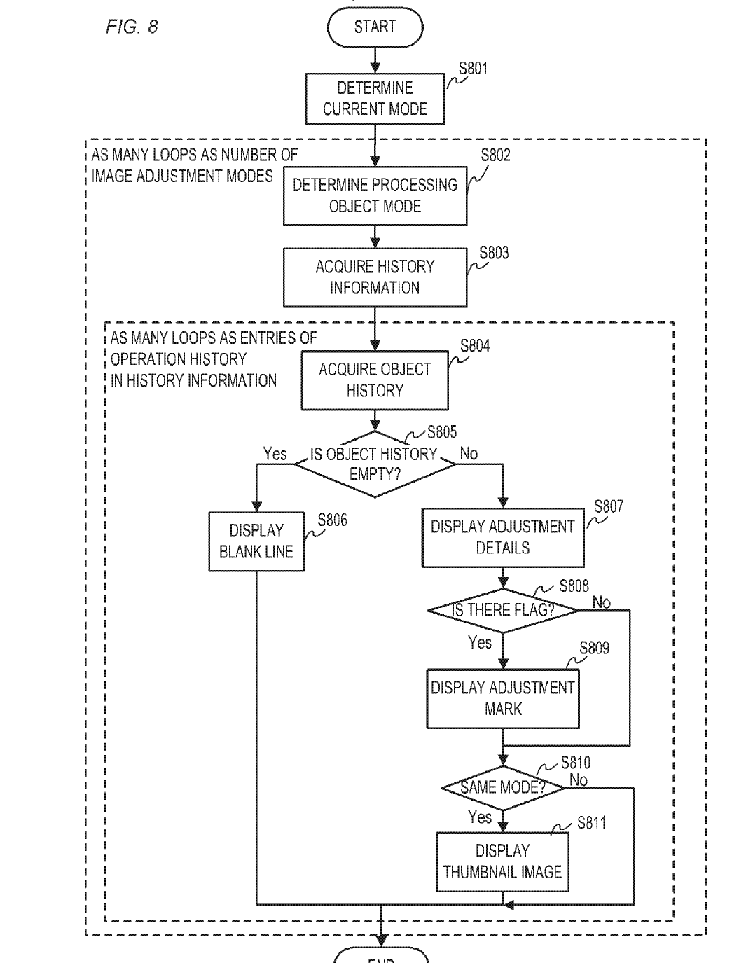

Operations of history display by the image processing apparatus 100 will be described with reference to the flow chart shown in FIG. 8. The processing of the present flow chart is specific processing of step S711.

In step S801, the mode acquiring unit 507 determines the current mode.

The processing of subsequent steps S802 to S811 is individually performed with respect to each of a plurality of switchable image adjustment modes. The image adjustment mode to be an object of the processing of S802 to S811 will be referred to as a “processing object mode”.

In step S802, the state display unit 505 determines the processing object mode among the plurality of switchable image adjustment modes.

In step S803, the state display unit 505 acquires history information corresponding to the processing object mode.

Hereinafter, in steps S804 to S811, processing is executed for each entry of operation history included in the history information of the processing object mode. Hereinafter, the operation history to be an object of processing of steps S804 to S811 will be referred to as “object history”.

In step S804, the history display unit 504 acquires the object history.

In step S805, the history display unit 504 determines whether or not the object history is empty. When the object history is determined to be empty, the history display unit 504 advances the processing to step S806. When the object history is determined not to be empty, the history display unit 504 advances the processing to step S807.

In step S806, the history display unit 504 displays a blank line as a display item indicating the object history.

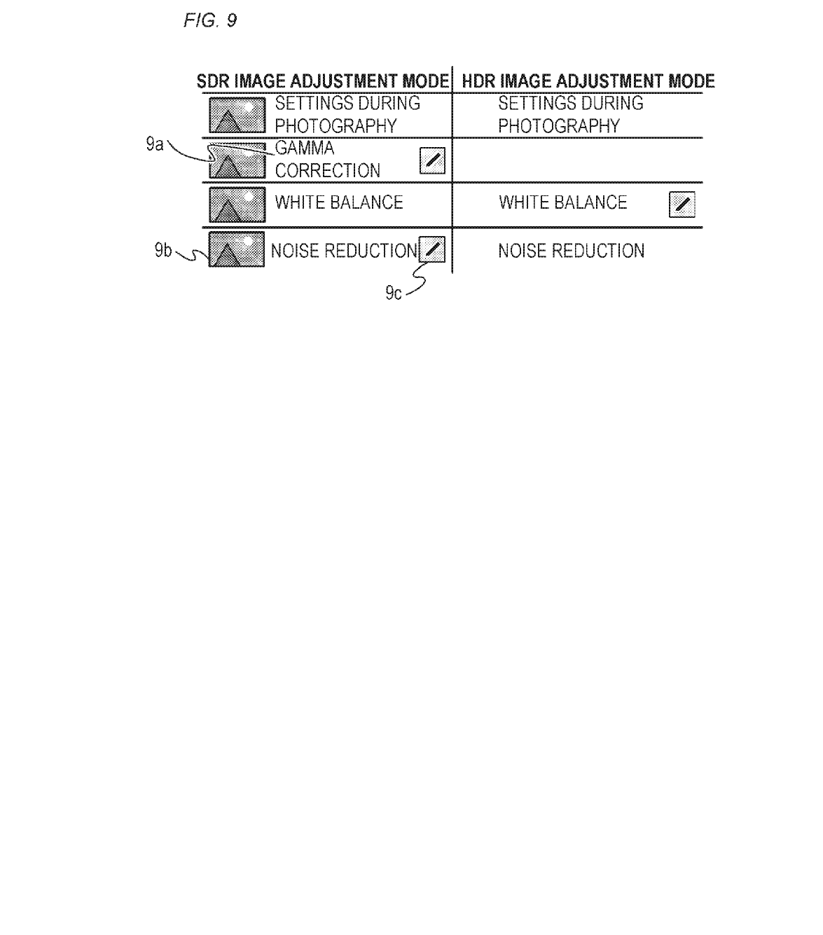

In step S807, the history display unit 504 displays image adjustment details included in the object history. For example, the history display unit 504 displays gamma correction as the image adjustment detail included in operation history 9a shown in FIG. 9. While only adjustment item names are displayed as image adjustment details in FIG. 9, finer adjustment details (such as parameters) may be displayed.

In step S808, the history display unit 504 determines whether or not an adjustment mode flag is included in the operation history. When it is determined that an adjustment mode flag is included, the history display unit 504 advances the processing to step S809. When it is determined that an adjustment mode flag is not included, the history display unit 504 advances the processing to step S810.

In step S809, as shown in FIG. 9, the history display unit 504 displays, next to the image adjustment details, an adjustment mark 9c indicating that image adjustment (image adjustment operation) corresponding to the image adjustment details was performed when the current mode was the processing object mode. While the history display unit 504 indicates that image adjustment corresponding to an image adjustment detail was performed during adjustment when the current mode was the processing object mode by means of a mark next to the image adjustment detail in the present embodiment, the means of indicating that the image adjustment was performed during adjustment in the processing object mode is not limited to a mark and need only be emphasized. Therefore, for example, the history display unit 504 may display characters indicating image adjustment details contained in the object history in bold or may display any display item indicating that the image adjustment was performed during adjustment in the processing object mode. Accordingly, the adjustment mode flag is used to indicate, in which image adjustment mode, the corresponding image adjustment was performed.

In step S810, the history display unit 504 determines whether or not the current mode and the processing object mode are the same mode. When the current mode and the processing object mode are determined to be the same mode, the processing advances to step S811. When the current mode and the processing object mode are determined to be different modes, the processing of the present flow chart ends.

In step S811, the image processing unit 502 generates a thumbnail image 9b corresponding to the image in the current mode as shown in FIG. 9. The history display unit 504 displays the thumbnail image 9b next to the image adjustment details included in the object history. While the history display unit 504 displays the thumbnail image only in history display of the current mode in order to facilitate determination of the current mode in the present embodiment, the thumbnail image may be displayed in the history display of all modes. In addition, the history display unit 504 may highlight the image adjustment mode name if the current mode can be indicated. In this case, the highlight is used as a user-interface indication of the current mode as a whole. That is, the history display unit 504 is capable of indicating which mode is currently active (the current mode).

As described above, in the image processing apparatus 100, for each image adjustment mode such as the SDR image adjustment mode and the HDR image adjustment mode, details of image adjustment applied to an image when the current mode is switched to the image adjustment mode are displayed as shown in FIG. 9. In addition, for each image adjustment mode, details of image adjustment not applied to an image when the current mode is switched to the image adjustment mode are not displayed. This being the case, for each image adjustment mode, details of image adjustment applied to the image when the current mode is switched to the image adjustment mode are displayed in an order of application (an order in which image adjustment operations were performed). Accordingly, the user can readily confirm an application state of image adjustment for each image adjustment mode during image adjustment.

Accordingly, even when the user adjusts an image by switching the mode among a plurality of image adjustment modes, the application state of image adjustment in each image adjustment mode can be confirmed. This makes it easier for the user to adjust the image.

Note that the above-described various types of control may be processing that is carried out by one piece of hardware (e.g., processor or circuit), or otherwise. Processing may be shared among a plurality of pieces of hardware (e.g., a plurality of processors, a plurality of circuits, or a combination of one or more processors and one or more circuits), thereby carrying out the control of the entire device.

Also, the above processor is a processor in the broad sense and includes general-purpose processors and dedicated processors. Examples of general-purpose processors include a central processing unit (CPU), a micro processing unit (MPU), a digital signal processor (DSP), and so forth. Examples of dedicated processors include a graphics processing unit (GPU), an application-specific integrated circuit (ASIC), a programmable logic device (PLD), and so forth. Examples of PLDs include a field-programmable gate array (FPGA), a complex programmable logic device (CPLD), and so forth.

The embodiment described above (including variation examples) is merely an example. Any configurations obtained by suitably modifying or changing some configurations of the embodiment within the scope of the subject matter of the present disclosure are also within the scope of the present disclosure. The present disclosure also includes other configurations obtained by suitably combining various features of the embodiment.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

According to the present disclosure, the user can readily confirm an application state of image adjustment for each image adjustment mode.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims priority to and the benefit of Japanese Patent Application No. 2025-003401, filed January 9, 2025, the entirety of which is incorporated herein by reference.

What is claimed is:

1. An image processing apparatus, comprising
one or more processors and one or more memories storing a program which, when executed by the one or more processors, causes the one or more processors to:
execute switching processing of switching a current mode among a plurality of image adjustment modes;
execute image adjustment processing of applying one or more image adjustments to an image in the current mode; and
execute display control processing of controlling a display so as to display, for each of the plurality of image adjustment modes, details of the one or more image adjustments applied to the image in a case where the current mode is switched to the image adjustment mode.

2. The image processing apparatus according to claim 1, wherein
in the display control processing, details of the one or more image adjustments applied to the image and of which adjustment parameters have been changed in an image adjustment mode before switching are displayed on the display.

3. The image processing apparatus according to claim 1, wherein
in the display control processing, for each of the plurality of image adjustment modes, the details of the one or more image adjustments applied to the image in a case where the current mode is switched to the image adjustment mode are displayed on the display in an order of application to the image by the image adjustment processing.

4. The image processing apparatus according to claim 1, wherein
in the image adjustment processing, image adjustment of at least any of white balance, gain, noise reduction, correction of lens characteristics, or gamma correction is capable of being applied to the image in the current mode.

5. The image processing apparatus according to claim 1, wherein
the plurality of image adjustment modes include an image adjustment mode corresponding to a high dynamic range (HDR) and an image adjustment mode corresponding to a standard dynamic range (SDR).

6. The image processing apparatus according to claim 1, wherein
in the display control processing, for each of the plurality of image adjustment modes, the details of the one or more image adjustments applied to the image when the image adjustment mode is the current mode among the details of the one or more image adjustments applied to the image in a case where the current mode is switched to the image adjustment mode are displayed in an enhanced manner.

7. The image processing apparatus according to claim 1, wherein
in the display control processing, a thumbnail image of the image is displayed in an area where the details of the one or more image adjustments applied to the image in the current mode among the plurality of image adjustment modes are to be displayed.

8. The image processing apparatus according to claim 1, wherein
in the display control processing, display is controlled so that, for each of the plurality of image adjustment modes, details of one or more image adjustments that are not applied to the image in a case where the current mode is switched to the image adjustment mode are not displayed.

9. The image processing apparatus according to claim 1, wherein
the details of the one or more image adjustments applied to the image include at least adjustment items or adjustment parameters.

10. An image processing method comprising:
switching a current mode among a plurality of image adjustment modes;
applying one or more image adjustments to an image in the current mode; and
controlling a display so as to display, for each of the plurality of image adjustment modes, details of the one or more image adjustments applied to the image in a case where the current mode is switched to the image adjustment mode.

11. A non-transitory computer readable medium that stores a program, wherein the program causes a computer to execute an image processing method comprising:
switching a current mode among a plurality of image adjustment modes;
applying one or more image adjustments to an image in the current mode; and
controlling a display so as to display, for each of the plurality of image adjustment modes, details of the one or more image adjustments applied to the image in a case where the current mode is switched to the image adjustment mode.
